(19) United States
(12) Patent Application Publication
(10) Pub. No.: US 2012/0207405 A1
(43) Pub. Date: Aug. 16, 2012

(54) SHOPPING BAG

(76) Inventor: Claude Roessiger, Wolfeboro, NH (US)

(21) Appl. No.: 13/025,067

(22) Filed: Feb. 10, 2011

(51) Int. Cl. B65D 33/06; B65D 33/00; B31B 1/26

(52) U.S. Cl. 383/6; 493/243; 383/105

(57) ABSTRACT

A creased paper capable of being assembled into a bag having interior and exterior sides, which includes from left to right, a first vertical side, a first comprehensive vertical away crease, a first comprehensive side toward crease, a second comprehensive vertical away crease, a third comprehensive vertical away crease, a second comprehensive side toward crease, and a second vertical side, which is also the essential edge; from top to bottom, a first horizontal side, a comprehensive horizontal away crease toward the bottom of the creased paper, and a second horizontal side; and four diagonal toward creases spanning between intersections of the comprehensive vertical away creases and essential edge with the comprehensive horizontal away crease to lateral crease termini located at an end of the comprehensive toward side creases.

### FIELD OF THE INVENTION

The present invention relates to shopping bags, and in particular, to shopping bags with no back face crease, that are thin when folded.

### BACKGROUND

Shopping bags are commonly used the world over as receptacles for purchased items. They come in many sizes, colors, and patterns. FIGS. 1A-1C show a typical prior art shopping bag 2 open in a perspective view, folded in a side view, and folded in a back view, respectively. Solid lines depict edges of prior art shopping bag 2 and dashed lines depict creases of prior art shopping bag 2. Prior art shopping bag 2 includes bottom flap 4, gusseting 6, bottom flap crease 8, handle 10, back panel 12, and front panel 14. Gusseting 6 allows shopping bag 2 to be expanded from a folded position, as shown in FIGS. 1B and 1C, to an open position, as shown in FIG. 1A. When folded, bottom flap 4 covers part of back panel 12 as it folds up over bottom flap crease 8. When expanded and open, prior art shopping bag 2 may rest upright with bottom flap 4 on the ground.

Although such a prior art shopping bag 2 is widely used, it suffers from at least three major disadvantages. First, as shown in FIG. 1B, because of how back panel 12 folds at bottom flap crease 8, prior art shopping bag 2 does not have uniform thickness when it is folded. At thick area 16, folded prior art shopping bag 2 has four layers of paper. As many stores, especially luxury or higher end stores, use thick, quality paper in their shopping bags, prior art shopping bag 2 can be quite thick through the thick area 16. Moreover, as prior art shopping bag 2 is not uniformly thick, stacking and storing large quantities of prior art shopping bags 2 is awkward. The second major disadvantage of prior art shopping bag 2 is that when opened or erected, the crease shows on the back panel 12. Back panel 12 is an area that may be used for marketing and advertising, and it is therefore advantageous for it to be fully exposed at all times. Finally, especially with bags made from less thick, lighter paper, even when open, prior art shopping bag 2 may list because it is difficult to fully straighten back panel 12 because of bottom flap crease 8.

Some efforts have been made to address some of these disadvantages. Barney's New York, for example, uses a shopping bag that does not include a fold or bottom panel 4. Although this means that the shopping bag lies much more flat that prior art shopping bag 2 shown in FIGS. 1A-1C and the front and back panels of the shopping bag are fully exposed at all times, this shopping bag also has its disadvantages: With no bottom panel 4, it cannot sit upright, and although it does include gusseting 6, it cannot expand very much, especially at the bottom.

Therefore there is a need for a paper shopping bag that includes the advantages of the prior art in that it includes a bottom panel 4, so that the shopping bag may sit upright when open and has plenty of room to expand, but overcomes the disadvantages of the prior art in that it lies flat, has front and back panels that are never covered by a bottom panel when folded, and does not include a crease on either front or back panel, such as bottom flap crease 8, that will tend to make the shopping bag list.

### SUMMARY OF THE INVENTION

The present invention includes a creased paper and a bag. In its most basic form the creased paper of the present invention is a piece of paper with an exterior side and an interior side, where the creased paper includes two parallel horizontal sides that are perpendicular to two vertical sides, three parallel comprehensive vertical creases, one comprehensive horizontal crease, three intersections where the comprehensive vertical creases and comprehensive horizontal crease meet, an essential edge parallel to the comprehensive vertical creases, an essential edge intersection where the essential edge and the comprehensive horizontal crease meet, two comprehensive side creases parallel to the comprehensive vertical creases, two lateral crease termini where the comprehensive side creases and one of the horizontal sides meet, and four diagonal creases spanning between the intersections or the essential edge intersection and the lateral crease termini. The creased paper may be made of any type of foldable paper or cardboard, but is preferably made of those types of paper commonly used to manufacture shopping bags, especially the thick, high quality paper often used to manufacture shopping bags for high end or luxury stores. The creased paper may be assembled to form a bag that may sit upright when open and may lie essentially flat when folded. It is understood that for features of the present invention, such as various creases and sides, to be considered “adjacent,” the features must be parallel to one another and there must not be another parallel feature between the adjacent features.

Each crease in the creased paper is either an “away” crease or a “toward” crease. That is to say that when one views one side of the creased paper, an away crease is creased so that the point of the crease points away from the viewer, and a toward crease is creased so that the point of the crease points toward the viewer. All creases herein designated as away or toward are done so based upon the assumption that the viewer is viewing the creased paper's interior side, or the side that would be the interior of the bag if the creased paper were assembled into a bag. It is understood that if the viewer were viewing the creased paper's exterior side, or the side that would be the exterior of the bag if the creased paper were assembled into a bag, then the away or toward designations would be reversed.

In the most basic embodiment of the creased paper of the present invention, the essential edge and one of the vertical sides are the same. Therefore, a preferred embodiment of the most basic form of the creased paper, envisioned from left to right, with the side that would be the interior of the bag if assembled facing out, would include a first vertical side, a first comprehensive vertical away crease, a first comprehensive side toward crease, a second comprehensive vertical away crease, a third comprehensive vertical away crease, a second comprehensive side toward crease, and a second vertical side, which is also the essential edge. From top to bottom, the same creased paper would include a first horizontal side, a comprehensive horizontal away crease toward the bottom of the creased paper, and a second horizontal side.

Finally, the same creased paper would include four diagonal toward creases. The first diagonal crease would span between an intersection, which is the intersection of the first comprehensive vertical crease and the comprehensive horizontal crease, and the lateral crease terminus, which is the intersection of the first comprehensive side crease and the second horizontal side. The second diagonal crease would span between another intersection, which is the intersection of the second comprehensive vertical crease and the comprehensive horizontal crease, and the same lateral crease terminus that is an end of the span of the first diagonal crease, as discussed above. The third diagonal crease would span between another intersection, which is the intersection of the third comprehensive vertical crease and the comprehensive horizontal crease, and another lateral crease terminus, which is the intersection of the second comprehensive side crease and the second horizontal side. The fourth diagonal crease would span between the essential edge intersection, which is the intersection of the second vertical side or essential edge and the comprehensive horizontal crease, and the same lateral crease terminus that is an end of the span of the third diagonal crease, as discussed above.

The creased paper of the present invention may also include a front panel flange away crease parallel to the comprehensive vertical creases, the comprehensive side creases, and the vertical sides. In such an embodiment, the essential edge is the front panel away crease, rather than the second vertical side, as described above. In this embodiment, therefore, the creased paper from left to right, would include a first vertical side, a first comprehensive vertical away crease, a first comprehensive side toward crease, a second comprehensive vertical away crease, a third comprehensive vertical away crease, a second comprehensive side toward crease, a front panel flange away crease, which is also the essential edge, and a second vertical side. The diagonal creases would be as above, with the fourth diagonal crease spanning between the essential edge intersection and the same lateral crease terminus as an end of the span of the third diagonal crease. The only difference would be that in this embodiment, the essential edge intersection is the intersection of the front panel flange crease, which is the essential edge in this case, and the comprehensive horizontal crease, rather than the intersection of the second vertical side and the comprehensive horizontal crease.

In such embodiments, a front panel flange is defined by the horizontal sides, the front panel flange crease, and the vertical side adjacent to the front panel flange crease. The front panel flange has a front panel flange interior, which is visible to the viewer of the interior side of the creased paper, and front panel flange exterior, which is the other side of the same area. One of the front panel flange interior or front panel flange exterior may include an adhesive so that it may be adhered to the other side of the creased paper so that the front panel flange crease and the first vertical side are collinear. The adhesive may be glue, double sided tape, or any other adhesive commonly used in the art.

The creased paper of the present invention may also include a top reinforcement away crease parallel to the comprehensive horizontal crease and the horizontal sides, positioned toward the top of the creased paper. In this embodiment, therefore, the creased paper, from top to bottom, would include a first horizontal side, a top reinforcement away crease toward the top of the creased paper, a comprehensive horizontal away crease toward the bottom of the creased paper, and a second horizontal side. These embodiments that include the top reinforcement crease may also include top reinforcements, which are preferably thin rectangular pieces of cardboard that are roughly commensurate with and adhered to the area of the creased paper defined by the first horizontal side, the top reinforcement crease, and the adjacent comprehensive vertical creases, and the area defined by the first horizontal side, the top reinforcement crease, the third comprehensive vertical crease, and the crease adjacent to the third comprehensive crease that is not a comprehensive side crease. Although thin rectangular cardboard top reinforcements are preferred, the top reinforcements may be made of paper, either the same paper as the creased paper is itself manufactured out of or other paper. The top reinforcements may also be other shapes besides rectangular and may be any of a range of thicknesses.

The creased paper of the present invention may also include two bottom panel halves, a bottom panel flange, and a bottom panel away crease. The first bottom panel half is the area of the creased paper defined by the comprehensive horizontal crease, the second horizontal side, and the adjacent comprehensive vertical creases. The second bottom panel half is the area of the creased paper defined by the comprehensive horizontal crease, the second horizontal side, the third comprehensive vertical crease, and the crease adjacent to the third comprehensive crease that is not a comprehensive side crease. The bottom panel flange is a piece of paper, preferably the same type of paper as the creased paper, extending from one of the bottom panel halves, where the bottom panel flange and the bottom panel half from which it extends are separated by the bottom panel crease, which is collinear with a portion of the second horizontal side. Similar to the front panel flange above, the bottom panel flange has an interior and an exterior, one of which may include an adhesive so that the bottom panel flange may be adhered to the bottom panel half from which the bottom panel flange does not extend.

In another embodiment, the creased paper of the present invention again includes two bottom panel halves as described in the last embodiment, at least one bottom front edge, a bottom reinforcement, and a bottom reinforcement edge. The bottom front edge is the edge of a bottom panel half that is a portion of the comprehensive horizontal crease. The bottom reinforcement is preferably a thin, rectangular piece of cardboard, similar to the top reinforcements, as described above, but with an area roughly commensurate with the area of the sum of the two bottom panel halves. The bottom reinforcement edge is an edge of the bottom reinforcement that is placed so as to be collinear with the bottom front edge of a bottom panel half and adhered thereto. In this way, when the creased paper is assembled into a bag, when the bag is folded, the bottom reinforcement may flip up to lie flush against the large area defined by the first horizontal side or top reinforcement crease, the comprehensive horizontal crease, and either the first vertical side and first comprehensive vertical crease or the second and third comprehensive vertical creases. When the bag is open, the bottom reinforcement may flip down to cover the bottom panel halves, which together form a bottom panel that provides a base for the bag. In these embodiments that include a bottom reinforcement, the creased paper of the present invention may also include a bottom reinforcement flange and a bottom reinforcement away crease. The bottom reinforcement flange is an extension of the bottom reinforcement that is separated from the remainder of the bottom reinforcement by the bottom reinforcement crease, which is collinear with the bottom reinforcement edge, the bottom front edge of the bottom panel half, and the comprehensive horizontal crease. The exterior side of the bottom reinforcement flange has an adhesive so that it may be adhered in place, thus securing the bottom reinforcement in place so that it may move as described above.

It is understood that the mirror image of the embodiments of the creased paper described above is also preferred and included within the present invention. That is to say, from left to right, the creased paper of the present invention may include a first vertical side, which is also the essential edge, (or a first vertical side and a front panel flange away crease, which is the essential edge), a first comprehensive side toward crease, a first comprehensive vertical away crease, a second comprehensive vertical away crease, a second comprehensive side toward crease, a third comprehensive vertical away crease, and a second vertical side. It is also understood that with the embodiments that include a bottom panel flange and/or a bottom reinforcement, the bottom panel flange and/or bottom reinforcement may be proximate to either bottom panel half. Moreover, it is understood that a front panel flange crease may be between a vertical side and a comprehensive vertical crease, rather than between a vertical side and a comprehensive side crease as described above.

The creased paper of the present invention may be assembled to form the bag of the present invention. In its most basic form, the bag of the present invention includes two front panels, each of which has a front panel top edge, a front panel bottom edge, and two front panel side edges; two side panels, each of which has a side panel top edge, a side panel bottom edge, two side panel side edges, and a side panel crease; four vertical creases where the side panels and front panels meet; a bottom panel with two bottom panel front edges and two bottom panel side edges, where the bottom panel edges connect with the front panel and side panel bottom edges and the bottom panel is divided into two bottom panel halves at a bottom panel crease; two horizontal creases where the bottom panel front edges meet the front panel bottom edges; and two expansion areas between the side panels and the bottom panel, where the expansion areas have a lateral crease, two diagonal creases, two lateral crease termini, and two intersections of the vertical creases and side bottom edges.

The bag may be made of any type of foldable paper or cardboard, but is preferably made of those types of paper commonly used to manufacture shopping bags, especially the thick, high quality paper often used to manufacture shopping bags for high end or luxury stores. When in its widest open position, the bag is essentially a rectangular prism of paper with one side missing. The exterior of the rectangular prism bag shows the two front panels with the side panels between them, the side panel creases down the center of the side panels, and the bottom panel connected to all other panels, with the bottom panel crease down the center of the bottom panel. The interior of the rectangular prism bag shows the interior sides of the front and side panels, and part of the expansion area overlaying the interior of the bottom panel. As the two front panels have no creases in them, but only at their sides where they meet the side panels and at their bottoms where they meet the bottom panel, the front panels do not list to one side or the other, but stand up relatively straight and upright when the bag is in an open position.

The various creases of the expansion area allow the bag to lie essentially flat when folded and in a manner so that the bottom panel does not cover any part of either of the front panels when folded. The lateral crease intersects at one end with the bottom of the side panel crease and extends straight down from there to the lateral crease terminus, so that the lateral crease bisects the expansion area and is an extension of and collinear with the side panel crease when the bag is folded and collinear with and parallel to the bottom panel crease when the bag is open. The diagonal creases extend from the intersections of the vertical creases with the bottom panel to the lateral crease termini. When the bag is flat, the expansion area is folded along the lateral creases and the diagonal creases are extended out flat, so that the bottom panel creases along the bottom panel crease and each bottom panel half is visible below one of the front panels. When the bag is open, the expansion area is folded along the diagonal creases and the lateral creases are extended out flat, so that the bottom panel crease is also extended flat to unite the two bottom panel halves into one flat bottom panel.

In a preferred embodiment, the bag of the present invention also includes a front panel flange or glue seam extending from one of the side panels and adhered to one of the front panels to provide some reinforcement of the seam connecting the two. It is preferred that the front panel flange extend from the side panel and be adhered to the front panel, but the front panel flange may also extend from a front panel and be adhered to a side panel. It is also preferred that the front panel flange be adhered on the interior of the bag so that it is not visible from the exterior of the bag, but the front panel flange may also be adhered on the exterior of the bag. Although adhering through glue, tape, or other adhesives common in the art, the front panel flange may also be attached by other means, such as stapling. So as to avoid interference with the side panel crease, it is preferred that the width of the front panel flange be less than half the width of the side panel.

In another preferred embodiment, the front panel top edges and side panel top edges are folded down into the interior of the bag to provide reinforcement at the bag's opening. This reinforcement may be augmented by the inclusion of top reinforcements, which are preferably thin rectangular pieces of cardboard that are roughly commensurate with the length of the front panel top edges and the width of the fold over of the front panel and side panel top edges. In an alternative embodiment, the top edges are not folded down, but top reinforcements are included. Although thin rectangular cardboard top reinforcements are preferred, the top reinforcements may be made of paper, either the same paper as the bag is itself manufactured out of or other paper. The top reinforcements may also be other shapes besides rectangular and may be any of a range of thicknesses.

In another preferred embodiment, the bag includes a bottom reinforcement, which is made of thin cardboard, like the top reinforcements. The bottom reinforcement is attached at the bottom reinforcement edge along one of the bottom panel front edges so that it may be flipped up to be flush with a front panel when the bag is in a folded position and flipped down to be flush with the bottom panel when the bag is in an open position. The bottom reinforcement may include a bottom reinforcement flange, which is an extension of the bottom reinforcement, and a bottom reinforcement crease between the bottom reinforcement and the bottom reinforcement flange. The bottom reinforcement crease is collinear with the bottom panel front edge, the front panel bottom edge, and the horizontal crease. The bottom reinforcement flange is preferably adhered in this position to the bottom panel.

In another preferred embodiment, the bag includes a bottom panel flange. The bottom panel flange extends from one of the bottom panel halves so that it may be adhered or otherwise attached to the opposing bottom panel halves. The bottom panel crease extends between the bottom panel flange and the bottom panel half from which the bottom panel flange extends. The bottom panel flange may be attached to the bottom panel half on the interior or the exterior of the bag. It is preferred that the bottom panel flange be folded over at its edge to avoid a raw edge.

Finally, it is preferred that the bag includes two handles attached to or integral to each of the front panels. The handles may be cut into the top of the front panels so that they are essentially holes in the top of the front panels. They may be cord, string, wire, or similar, whose ends are adhered to the interior of the front panels. They may be cord, string, wire, or similar that are tied in knots at their ends and threaded through holes in the front panels. These are but a few examples of the many handles commonly used in the art of shopping bags that are contemplated as falling within the scope of the present invention. Regardless of the type of handles, it is preferable that the bag be reinforced where the handles meet the front panel. This reinforcement may be as described above, by folding down the top edges, including top reinforcements, or both.

Therefore it is an aspect of the present invention to provide a creased paper that may be assembled into a bag that lies essentially flat when folded.

It is a further aspect of the present invention to provide a creased paper that may be assembled into a bag that includes a bottom panel that never covers any part of the front panels when folded.

It is a further aspect of the present invention to provide a creased paper that may be assembled into a bag that may be set down on its bottom panel to sit upright.

It is a further aspect of the present invention to provide a creased paper that may be assembled into a bag that includes front panels that do not include creases that may cause the bag to list to one side when open.

It is a further aspect of the present invention to provide a creased paper that may be assembled into a bag that includes a front panel flange for easily assembling the bag.

It is a further aspect of the present invention to provide a creased paper that may be assembled into a bag that includes a reinforced top.

It is a further aspect of the present invention to provide a creased paper that may be assembled into a bag that includes a reinforced bottom.

It is a further aspect of the present invention to provide a creased paper that may be assembled into a bag that includes a bottom panel flange for easily connecting the two halves of the bottom panel.

It is a further aspect of the present invention to provide a bag that lies essentially flat when folded.

It is a further aspect of the present invention to provide a bag that includes a bottom panel that never covers any part of the front panels when folded.

It is a further aspect of the present invention to provide a bag that may be set down on its bottom panel to sit upright.

It is a further aspect of the present invention to provide a bag that includes front panels that do not include creases that may cause the bag to list to one side when open.

It is a further aspect of the present invention to provide a bag that includes a front panel flange for easily assembling the bag.

It is a further aspect of the present invention to provide a bag that includes a reinforced top.

It is a further aspect of the present invention to provide a bag that includes a reinforced bottom.

It is a further aspect of the present invention to provide a bag that includes a bottom panel flange for easily connecting the two halves of the bottom panel.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIG. 1A is a perspective view of an open prior art shopping bag.

FIG. 1B is a side view of a folded prior art shopping bag.

FIG. 1C is a back view of a folded prior art shopping bag.

FIG. 2 is a diagram of the creased paper of the present invention.

FIG. 3A is a perspective view of an open bag of the present invention.

FIG. 3B is an alternate perspective view of an open bag of the present invention.

FIG. 3C is a front view of the exterior of a folded bag of the present invention.

FIG. 3D is a side view of the exterior of a folded bag of the present invention.

FIG. 3E is a top down view of the interior of an open bag of the present invention.

FIG. 3F is a top down view of the interior of an open bag of the present invention that includes bottom reinforcement.

FIG. 3G is a front view of the interior of the front panel of a folded bag of the present invention that includes bottom reinforcement.

FIG. 3H is an isolated view of the expansion area of the creased paper of the present invention.

### DETAILED DESCRIPTION

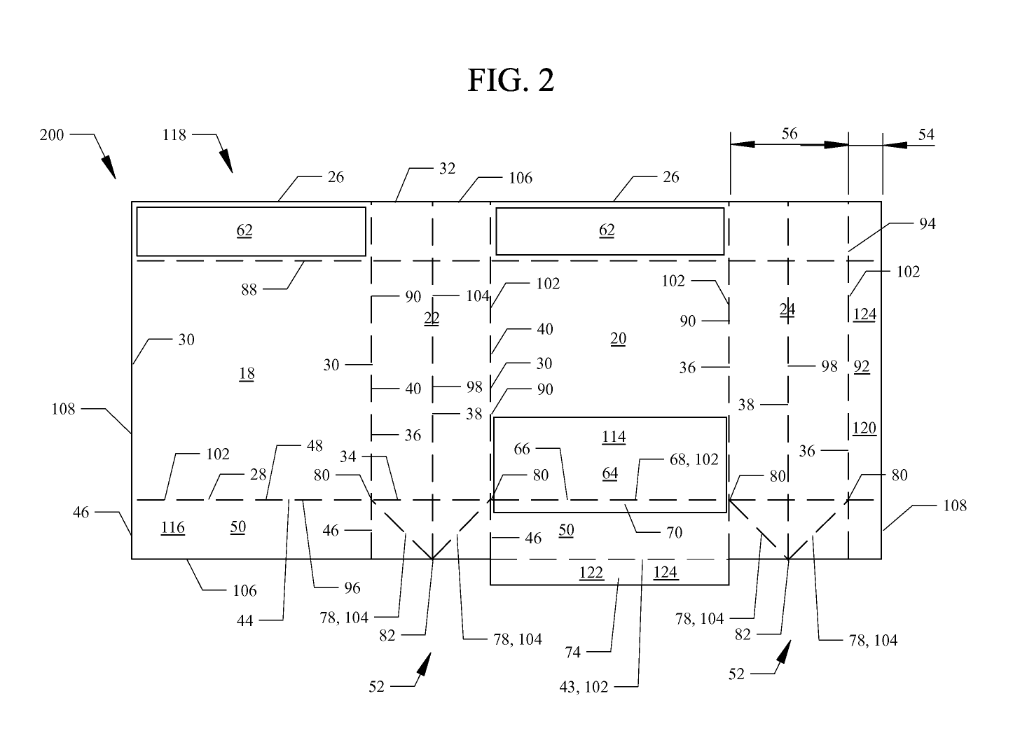

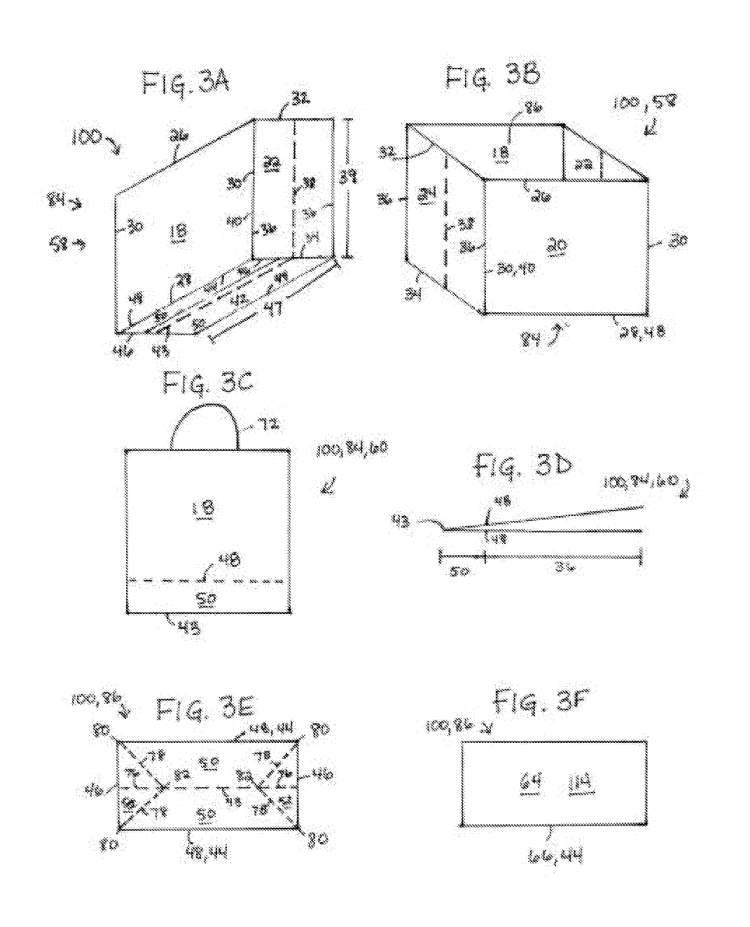

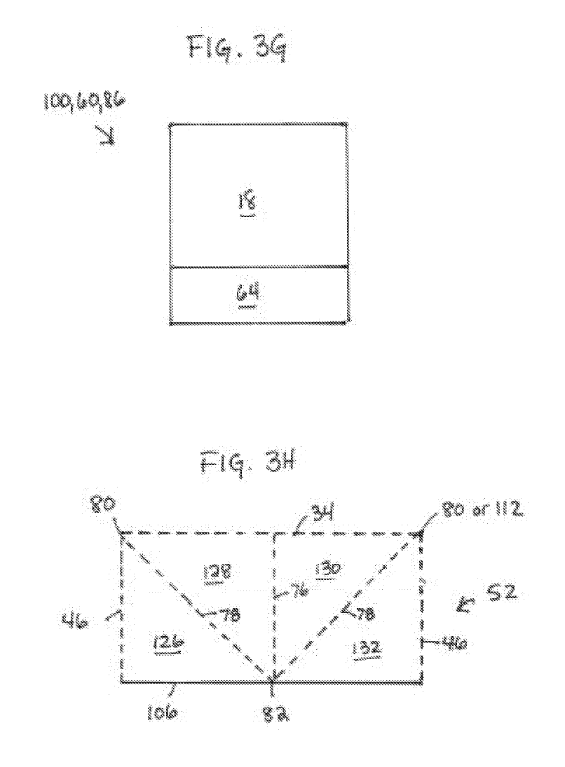

Referring first to FIG. 2, creased paper 200 of the present invention is shown. Several reference numbers for bag 100 of the present invention, discussed below, are included in this FIG. for further reference for bag 100, but may not be discussed here with reference to creased paper 200. In all figures, dashed lines indicate creases and solid lines indicate edges. Creased paper 200 may be assembled into bag 100. FIG. 2 shows interior 118 of creased paper 200, meaning these surfaces will be interior 86 (see FIG. 3B, for example) of bag 100 when creased paper 200 is assembled.

The most basic embodiment of creased paper 200 includes, from left to right, first vertical side 108, first comprehensive vertical crease 90, first comprehensive side crease 98, second comprehensive vertical crease 90, third comprehensive vertical crease 90, second comprehensive side crease 98, and second vertical side 108, which is, in this most basic embodiment, also essential edge 110; from top to bottom, first horizontal side 106, comprehensive horizontal crease 96 toward the bottom of creased paper 200, and second horizontal side 106; three intersections 80 where comprehensive vertical creases 90 meet comprehensive horizontal crease 96; essential edge intersection 112 where essential edge 110 meets comprehensive horizontal crease 96; two lateral crease termini 82 where comprehensive side crease 98 meets second horizontal side 106; and four diagonal creases 78 extending from intersections 80 or essential edge intersection 112 to lateral crease termini 82. Each crease is either an “away” crease 102, in that the crease, if folded, would point away from the viewer, or a “toward” crease 104, in that the crease, if folded would point toward the viewer. All creases except for comprehensive side creases 98 and diagonal creases 78 are away creases 102. Comprehensive side creases 98 and diagonal creases 78 are toward creases 104.

To form bag 100 from this most basic embodiment of creased paper 200, tape or another adhesive or connector would be applied to join first and second vertical sides 108. It would also be applied to join the portion of second horizontal side 106 between first vertical side 108 and first comprehensive vertical crease 90 with the portion of second horizontal side 106 between second comprehensive vertical crease 90 and third comprehensive vertical crease 90. These joinings would produce front panels 18, 20, side panels 22, 24, and bottom panel 42 with bottom panel halves 50 and bottom panel crease 43. For bag 100 in folded position 60, comprehensive side creases 98, comprehensive vertical creases 90, and bottom panel crease 43, would be completely folded so that diagonal creases 78 and comprehensive horizontal crease 96 extend flat. For bag 100 in open position 58, comprehensive vertical creases 90 and comprehensive horizontal crease 96 would be folded half way so that approximately 90° angles are formed between side panels 22, 24, front panels 18, 20, and bottom panel 42; comprehensive side creases 98 and bottom panel crease 43 would be extended flat; and diagonal creases 78 would be folded completely.

The preferred embodiment of creased paper 200 also includes front panel flange crease 94, which produces front panel flange 92. When front panel flange crease 94 is included, front panel flange crease 94 is essential edge 110, as shown in FIG. 2. Front panel flange 92 has interior side 120, shown in FIG. 2 and exterior side, not visible in FIG. 2, but understood to be the other side of front panel flange 92. One of interior side 120 and exterior side of front panel flange 92 preferably includes adhesive 124 for ease of adhering front panel flange 92 to first front panel 18. It is preferred that the side of front panel flange 92 that includes adhesive 124 be exterior side so that it may be adhered to the interior side of first front panel 18 so that front panel flange 92 is not visible from exterior 84 of bag 100.

The preferred embodiment of creased paper 200 also includes top reinforcement crease 88 and top reinforcements 62 to reinforce the opening of bag 100.

The preferred embodiment of creased paper 200 also includes bottom panel halves 50, bottom panel crease 43, and bottom panel flange 74. Bottom panel flange 74 extends from one of bottom panel halves 50 and preferably includes adhesive 124 for ease of adhering bottom panel flange 74 to the other bottom panel half 50. Bottom panel crease 43 separates bottom panel flange 74 from bottom panel half 50 from which bottom panel flange 74 extends.

The preferred embodiment of creased paper 200 also includes bottom reinforcement 64 which meets bottom panel front edge 44 at bottom reinforcement edge 66. Bottom panel front edge 44 and bottom reinforcement edge 66 are both collinear with comprehensive horizontal crease 96. Bottom reinforcement 64 reinforces and is flush with bottom panel 42 when bag 100 is in open position 58. Bottom reinforcement 64 flips up to be flush with second front panel 20 when bag 100 is in folded position 60. Bottom reinforcement flange 70 extends from bottom reinforcement 64, is divided from bottom reinforcement 64 by bottom reinforcement crease 68, and is adhered to bottom panel half 50. Bottom reinforcement 64 has an area 114 roughly commensurate with the sum of bottom half panel areas 116.

Now referring to FIGS. 3A-3H, bag 100 of the present invention is shown. Creased paper 200 may be assembled to form bag 100. FIG. 3A is a perspective view of exterior 84 of bag 100 in open position 58. Bag 100 includes first front panel 18, first side panel 22, and bottom panel 42. First front panel 18 includes front panel top edge 26, front panel bottom edge 28, and front panel side edges 30. First side panel 22 includes side panel top edge 32, side panel bottom edge 34, side panel side edges 36, and side panel crease 38 running length 39 of side panel 22. Front panel side edges 30 and side panel side edges 36 meet at vertical crease 40. Bottom panel 42 includes bottom panel front edges 44, bottom panel side edges 46, bottom half panels 50, and bottom panel crease 43 running length 47 of bottom panel 42 between bottom half panels 50. Bottom panel front edges 44 meet front panel bottom edges 28 at horizontal crease 48. Bottom panel side edges 46 meet side panel bottom edges 34 when bag 100 is in open position 58. This meeting is facilitated by expansion area 52, discussed below with reference to FIGS. 3E and 3H.

FIG. 3B is an alternate perspective view of bag 100 in open position 58 where exterior 84 and some of interior 86 are visible. Exterior 84 of second front panel 20 and second side panel 24 are visible, as are a portion of interior 86 of first front panel 18 and first side panel 22.

FIG. 3C is a front view of exterior 84 of bag 100 in folded position 60. Handle 72 is included in this embodiment of bag 100. In this view, we see first front panel 18 and bottom panel half 50 extending away from first front panel 18 with horizontal crease 48 extended and bottom panel crease 43 completely folded.

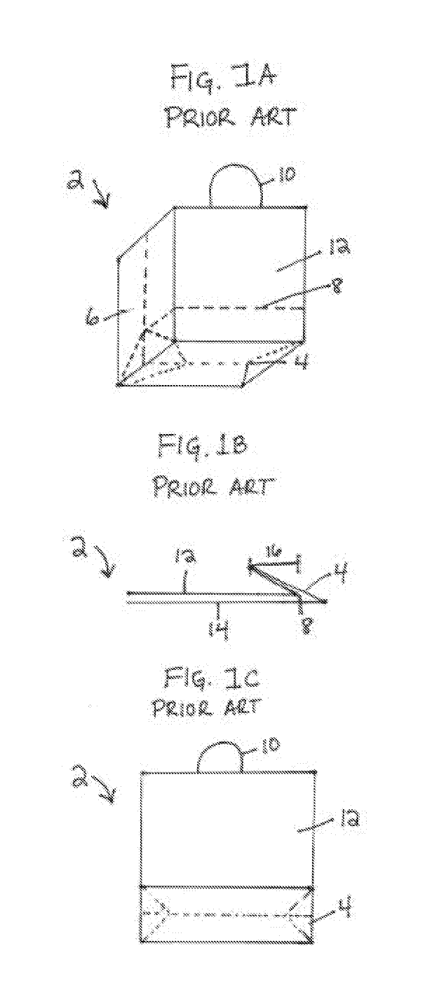

FIG. 3D is a side view of exterior 84 of bag 100 in folded position 60. In this view, we see that bottom panel halves 50 are extended from side panel side edges 36 and horizontal crease 48 is extended flat. Bag 100 is quite thin when in folded position 60 and of uniform thickness. Especially when comparing bag 100 of the present invention in FIG. 3D with prior art shopping bag in FIG. 1B, it is clear that bag 100 is significantly thinner, and will stack more easily as its thickness is just two sheets of paper throughout its length.

FIG. 3E is a top down view of interior 84 of bag 100 in open position 58. The inside of back panel 42, with back panel halves 50, back panel crease 43, back panel side edges 46, and back panel front edges 44, coinciding with horizontal crease 48, are visible. Also visible is expansion area 52. When bag 100 is in open position 58, lateral crease 76 is extended flat and diagonal creases 78 are completely folded, so that only half of each expansion area 52 is visible. We also see intersections 80, where vertical creases 40 meet back panel 42 and side panel bottom edges 34, and lateral crease termini 82, which are the ends of lateral creases 76 that do not intersect bottom panel side edge 46 and side panel bottom edge 34. Diagonal creases 78 span between intersections 80 and lateral crease termini 82.

FIG. 3F is a top down view of interior 86 of bag 100 in open position 58 where bag 100 includes bottom reinforcement 64. Bottom reinforcement 64 meets bottom panel front edge 44 at bottom reinforcement edge 66, both of which are collinear with horizontal crease 48. Bottom reinforcement 64 is flush with bottom panel 42 when bag 100 is in open position 58. This provides reinforcement for bottom panel 42 and also covers up bottom crease 43 and expansion area 52, which may give bag 100 an unfinished look. Bottom reinforcement 64 has an area 114 approximately equal to the sum of the areas of bottom panel halves 116, as shown in FIG. 2. Also as shown in FIG. 2, bottom reinforcement flange 70 extends from bottom reinforcement 64, is divided from bottom reinforcement 64 by bottom reinforcement crease 68, and is adhered to bottom panel half 50.

FIG. 3G is a front view of interior 86 of first front panel 18 of bag 100 in folded position 60 with bottom reinforcement 64. Bottom reinforcement 64 flips up to be flush with first front panel 18 when bag 100 is in folded position 60. It is understood that bottom reinforcement may also be adhered to the other side of bag 100 so that it flips up to be flush with second front panel 20.

As shown in FIG. 2, bag 100 also preferably includes bottom panel flange 74. Bottom panel flange 74 extends from one of bottom panel halves 50 and preferably includes adhesive 124 for ease of adhering bottom panel flange 74 to the other bottom panel half 50. Bottom panel flange 74 has interior 122 and exterior, not visible, but understood to be on the other side of the paper from interior 122. Adhesive may be applied to either interior 122 or exterior. The edge of bottom panel flange 74 may be folded over to avoid a raw edge. Bottom panel crease 43 separates bottom panel flange 74 from bottom panel half 50 from which bottom panel flange 74 extends.

FIG. 3H is an isolated view of expansion area 52 of creased paper 200. As expansion area 52 is never completely flat in bag 100, as it is creased paper 200, it is illustrative to consider it here. When bag 100 is in open position 58, lateral creases 76 are extended flat and diagonal creases 78 are completely folded over so that sections 126 and 132 are folded under sections 128 and 130, respectively. This occurs in conjunction with bottom panel crease 43 extending flat to form bottom panel 42 and vertical creases 40, horizontal creases 48, and side creases 38 partly opening to form the rest of the bag. At its most wide open, bag 100, will resemble a rectangular prism with vertical creases 40, horizontal creases 48, and side creases all open so that front panels 18, 20, side panels 22, 24, and bottom panel 42 are at 90° angles from one another. When bag 100 is in folded position 60, lateral creases 76 are completely folded and diagonal creases 78 are extended flat so that sections 126 and 128 are flat and form a rectangle, as do sections 130 and 132. These two rectangles are flush against one another and are essentially extensions of side panels 22, 24, with lateral crease 76 being an extension of side crease 38. As we saw in FIG. 3C, bottom panel halves 50 are below front panels 18, 20 when bag 100 is in folded position 60. Although not shown in FIG. 3C, it is understood that side panels 22, 24 are folded behind front panel 18. Similarly, expansion areas 52, are folded behind bottom panel half 50. In conjunction with the changes described above in expansion area 52 when bag 100 is in folded position, vertical creases 40, side creases 38, and bottom panel crease 43 area all completely folded, while horizontal creases 48 are fully extended flat.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

We claim:

1. A creased paper comprising an exterior side and an interior side, wherein said creased paper is capable of being assembled into a bag and comprises:
two parallel horizontal sides and two parallel vertical sides, wherein said horizontal sides are perpendicular to said vertical sides;
three parallel comprehensive vertical creases, wherein said comprehensive vertical creases are away creases and parallel to said vertical sides;
a comprehensive horizontal crease perpendicular to said comprehensive vertical creases, wherein said horizontal crease is an away crease;
three intersections where said comprehensive vertical creases and said comprehensive horizontal crease meet;
an essential edge parallel to said vertical comprehensive creases and perpendicular to said comprehensive horizontal crease;
an essential edge intersection where said essential edge and said comprehensive horizontal crease meet;
two comprehensive side creases, parallel to said comprehensive vertical creases and perpendicular to said comprehensive horizontal crease, wherein said side creases are toward creases;
two lateral crease termini where said comprehensive side creases and one of said horizontal sides meet; and
four diagonal creases, two of which span from two of said intersections to one of said lateral crease termini, one of which spans from the third of said intersections to the other of said lateral crease termini, and one of which spans from said essential edge intersection to the other of said lateral crease termini, wherein said diagonal creases are toward creases.

2. The creased paper as claimed in claim 1 wherein one of said vertical sides is said essential edge.

3. The creased paper as claimed in claim 1 further comprising a front panel flange crease parallel and adjacent to one of said vertical sides, wherein said front panel flange crease is an away crease and said front panel flange crease is said essential edge.

4. The creased paper as claimed in claim 3, wherein said front panel flange crease, said horizontal sides, and the one of said vertical sides to which said front panel flange crease is adjacent define a front panel flange; said front panel flange comprises a front panel flange interior and a front panel flange exterior; and one of said front panel flange interior and said front panel flange exterior comprises an adhesive.

5. The creased paper as claimed in claim 1 further comprising a top reinforcement crease parallel to said comprehensive horizontal crease, wherein said top reinforcement crease is an away crease.

6. The creased paper as claimed in claim 5, further comprising two top reinforcements both of which are positioned directly proximate to said top reinforcement crease, the first of which is further positioned between said comprehensive vertical creases that are adjacent to one another, and the second of which is positioned between the third of said comprehensive vertical creases and an adjacent crease that is not one of said comprehensive side creases.

7. The creased paper as claimed in claim 1 further comprising:
two bottom panel halves:
the first of which is defined by said comprehensive horizontal crease, said horizontal side that is adjacent to said comprehensive horizontal crease, and said comprehensive vertical creases that are adjacent to one another; and
the second of which is defined by said comprehensive horizontal crease, said horizontal side that is adjacent to said comprehensive horizontal crease, and the third of said comprehensive vertical creases and an adjacent crease that is not one of said comprehensive side creases;
a bottom panel flange proximate to one of said bottom panel halves; and
a bottom panel crease between said bottom panel flange and the one of said bottom panel halves to which said bottom panel flange is proximate, wherein said bottom panel crease is an away crease.

8. The creased paper as claimed in claim 7, wherein said bottom panel flange comprises a bottom panel flange interior and a bottom panel flange exterior and one of said bottom panel flange interior and said bottom panel flange exterior comprises an adhesive.

9. The creased paper as claimed in claim 1 further comprising two bottom panel halves, at least one bottom panel front edge, a bottom reinforcement, and a bottom reinforcement edge:
wherein one of said bottom panel halves is defined by one of said comprehensive horizontal crease, said horizontal side that is adjacent to said comprehensive horizontal crease, and said comprehensive vertical creases that are adjacent to one another;
wherein the other of said bottom panel halves is defined by said comprehensive horizontal crease, said horizontal side that is adjacent to said comprehensive horizontal crease, and the third of said comprehensive vertical creases and an adjacent crease that is not one of said comprehensive side creases;
wherein said bottom panel front edge is a side of one of said bottom panel halves that is collinear with said comprehensive horizontal crease;
wherein an area of said bottom reinforcement is commensurate with the sum of areas of said two bottom panel halves; and
said bottom reinforcement edge of said bottom reinforcement is collinear with said bottom front edge of one of said bottom panel halves and said comprehensive horizontal crease.

10. The creased paper as claimed in claim 9 further comprising a bottom reinforcement flange and a bottom reinforcement crease:
wherein said bottom reinforcement flange is integral to said bottom reinforcement, adhered to one of said bottom panel halves, and divided from said bottom reinforcement by said bottom reinforcement crease; and
wherein said bottom reinforcement crease is an away crease and is collinear with said comprehensive horizontal crease.

11. A paper bag comprising an exterior and an interior, wherein said bag is capable of being in a folded state and an open state and said bag further comprises:
a first front panel and a second front panel, each of which comprise a front panel top edge, a front panel bottom edge, and two front panel side edges;
a first side panel and a second side panel, each of which comprise a side panel top edge, a side panel bottom edge, two side panel side edges, and a side panel crease running down a length of said two side panels, parallel to said side panel side edges;
four vertical creases, wherein said first and second side panels extend between said first and second front panels such that said front panel side edges and said side panel side edges are collinear and form said vertical creases;
a bottom panel comprising two bottom panel front edges, two bottom panel side edges, two bottom panel halves, and a bottom panel crease:
wherein said bottom panel extends between said front panel bottom edges of said first and second front panels;
wherein said bottom panel extends between said side panel bottom edges of said first and second side panels when said bag is in said open position;
wherein said bottom panel crease separates said two bottom panel halves and runs across a length of said bottom panel, parallel to said bottom panel front edges;
wherein said bottom panel forms a rectangular base for said bag when said bag is in said open position; and
wherein each of said bottom panel halves are visible on either side of said exterior of said bag below and away from said first and second front panels when said bag is in said folded position;
two horizontal creases, wherein said front panel bottom edges of said first and second front panels and said bottom panel front edges are collinear and form said horizontal creases;
two expansion areas, each of which comprises a lateral crease, two diagonal creases, a lateral crease terminus, and two intersections of said vertical creases and said side bottom edges:
wherein each of said expansion areas span between one of said bottom panel side edges and one of said side panel bottom edges;
wherein said lateral creases are a continuation of said side panel creases and perpendicular to said bottom panel crease when said bag is in said folded position;
wherein said lateral creases are parallel to said bottom panel crease and perpendicular to said side panel creases when said bag is in an open position;
wherein said lateral crease termini are ends of said lateral creases that do not intersect said side panel bottom edges; and
wherein said diagonal creases run from said intersections to said lateral crease termini.

12. The bag as claimed in claim 11 further comprising a front panel flange proximate to one of said vertical folds and attached to one of the group consisting of said front panel side edges and said side panel front edges.

13. The bag as claimed in claim 12 wherein said front panel flange comprises a front panel flange width and said first and second side panels comprise a side panel width and said front panel flange width is less than half of said side panel width.

14. The bag as claimed in claim 11 wherein said front panel top edges of said first and second front panels and said side panel top edges of said first and second side panels are folded down into said interior of said bag.

15. The bag as claimed in claim 11 further comprising two top reinforcements on said interior of said bag, wherein said top reinforcements are positioned proximate to said front panel top edges of said first and second front panels on said interior of said bag.

16. The bag as claimed in claim 11 further comprising two top reinforcements on said interior of said bag, wherein said top reinforcements are positioned proximate to said front panel top edges of said first and second front panels on said interior of said bag, and wherein said front panel top edges of said first and second front panels and said side panel top edges of said first and second side panels are folded down into said interior of said bag and over said two top reinforcements.

17. The bag as claimed in claim 11 further comprising a bottom reinforcement in said interior of said bag, wherein said bottom reinforcement comprises a bottom reinforcement edge, wherein said bottom reinforcement edge is collinear with said horizontal crease, wherein when said bag is in said folded position, said bottom reinforcement is flush with one of said first and second front panels, and wherein when said bag is in said open position, said bottom reinforcement is flush with said bottom panel.

18. The bag as claimed in claim 17 further comprising a bottom reinforcement flange and a bottom reinforcement crease wherein said bottom reinforcement flange is integral to said bottom reinforcement, wherein said bottom reinforcement flange and said bottom reinforcement are separated by said bottom reinforcement crease, wherein said bottom reinforcement crease and said bottom reinforcement edge are collinear, and wherein said bottom reinforcement flange is attached to said bottom panel.

19. The bag as claimed in claim 11, further comprising a bottom panel flange integral to and extending from one of said two bottom panel halves at said bottom panel crease and attached to said other of said two bottom panel halves.

20. The bag as claimed in claim 11 further comprising a handle.
